(19) United States
(12) Patent Application Publication
(10) Pub. No.: US 2004/0203736 A1
(43) Pub. Date: Oct. 14, 2004

(54) Method, network node and system for selecting network nodes

(76) Inventor: Pedro Serna, Malaga (ES)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/299,998

(22) Filed: Nov. 20, 2002

(51) Int. Cl. H04Q 7/20; H04L 12/66

(52) U.S. Cl. 455/426.1; 370/328; 370/352; 455/435.1

(57) ABSTRACT

The present invention describes a method, system, IP base station and radio network access server for identifying and selecting network nodes in a telecommunication system comprising a core network comprising a plurality of core network nodes, a plurality of radio network access servers belonging to one or more pool-areas and one or more IP base stations each of which being connected to one or more radio network access servers and a plurality of mobile terminals connected to one or more IP base stations. In the method, a core network node and a radio network access server in the pool-area is selected in connection with the core network node at the time of setting up a signaling connection to the core network and address information of the selected core network node to be used in the signaling connection set-up is sent to the selected radio network access server.

### FIELD OF THE INVENTION

The present invention relates to the telecommunication systems. In particular, the present invention relates to a novel and improved method, system, IP base station and radio network access server for identifying and selecting radio network access servers and core network nodes in a distributed radio access network.

### BACKGROUND OF THE INVENTION

In the current specifications of the third generation mobile networks (referred to as UMTS), the system utilizes the same well-known architecture that has been used by all main second generation systems. A block diagram of the system architecture of current UMTS network is presented in FIG. 1. The UMTS network architecture includes the core network (CN), the UMTS terrestrial radio access network (UTRAN), and the user equipment (UE) . The core network is further connected to the external networks, i.e. Internet, PLMN, PSTN and/or ISDN.

The GSM Phase 1/2 Core Network consists of network switching subsystem (NSS). The NSS further consists of the following functional units: Mobile Switching Center (MSC), Visitor Location Register (VLR), Home Location Register (HLR), Authentication Center (AC) and equipment identity register (EIR). The GSM Phase 2+ enhancements to the GSM phase 1/2 CN are serving GPRS (General Packet Radio Service) support node (SGSN), gateway GPRS support node (GGSN) and CAMEL service environment. The most important new feature that is introduced with GPRS is packet switching (PS) which improves the capacity of the network.

The UTRAN architecture consists of several radio network subsystems (RNS). The RNS is further divided into the Radio Network Controller (RNC) and several base stations (BTS, referred to as B nodes in the 3^{rd} Generation Partnership Project (3GPP) GPP specifications).

In this architecture there are several different connections between the network elements. The Iu interface connects the CN to the UTRAN. The Iur interface enables the exchange of signaling information between two RNCs. The signaling protocol across the Iur interface is called the Radio Network Subsystem Application Part (RNSAP). The RNSAP is terminated at both ends of the Iur interface by an RNC. The Iub interface connects an RNC and a node B. The Iub interface allows the RNC and node B to negotiate about radio resources, for example, to add and delete cells controlled by node B to support communication of dedicated connection between UE and S-RNC, information used to control the broadcast and paging channels, and information to be transported on the broadcast and paging channels. One node B can serve one or multiple cells. The UE is connected to node B through the Uu radio interface. The UE further consists of a subscriber identity module (USIM) and mobile equipment (ME). They are connected by the Cu interface. Connections to external networks are made through Gateway MSC (towards circuit switched networks) or GGSN (towards packet switched networks).

The Intra Domain Connection of RAN Nodes to Multiple CN Nodes overcomes the strict hierarchy, which restricts the connection of an RAN node to just one CN node. The Intra Domain Connection of RAN Nodes to Multiple CN Nodes introduces further the concept of ‘pool-areas’ which is enabled by the routing mechanism in the RAN nodes. A pool-area is comparable to an MSC or SGSN service area as a collection of one or more RAN node service areas. In difference to an MSC or SGSN service area a pool-area is served by multiple CN nodes (MSCs or SGSNs) in parallel which share the traffic of this area between each other. Furthermore, pool-areas may overlap which is not possible for MSC or SGSN service areas.

From a RAN perspective a pool-area comprises all Location Area(s)/Routing Area(s) of one or more RNC/BSC that are served by a certain group of CN nodes in parallel. One or more of the CN nodes in this group may in addition serve LAs/RAs outside this pool-area or may also serve other pool-areas. This group of CN nodes is also referred to as MSC pool or SGSN pool respectively.

The Network Resource Identifier (NRI) identifies uniquely an individual CN node out of all CN nodes, which serve in parallel a pool-area. The length of the NRI shall be the same in all nodes of a domain in one pool-area. In areas where pool-areas overlap the NRI identifies uniquely a CN node out of all CN nodes, which serve all these overlapping pool-areas, i.e. an NRI identifies uniquely a CN node within a RAN node. In case of overlapping pool-areas the NRI length shall be configured to be the same in all the nodes of a specific domain serving these pool-areas. The NRI is part of the temporary identity TMSI (CS domain) or PTMSI (PS domain), which is assigned by the serving CN node to the MS.

In Iu mode the MS provides an Intra Domain NAS Node Selector (IDNNS) in the Access Stratum part of the RRC-Initial-direct-transfer message to the RAN node. The IDNNS contains a routing parameter with a fixed length of 10 bits. This routing parameter transports the NRI value. In addition the IDNNS contains an indication from which identity (TMSI, IMSI, IMEI, . . . ) the routing parameter is derived.

NAS node selection function (NNSF) is used in RAN nodes and potentially in CN nodes. In the RAN node the function selects the specific CN node (i.e. MSC or SGSN) to which initial NAS signaling messages or LLC frames are routed. The NRI identifies the specific CN node. If the NAS Node Selection Function has a CN node address configured for the NRI derived from the initial NAS signaling message or from the LLC frame then this message or frame is routed to this address. If no CN node address is configured for the derived NRI or if no NRI can be derived (e.g. the MS indicated an identity which contains no NRI) then the NAS Node Selection Function selects an available CN node (e.g. according to load balancing) and routes the message or LLC frame to the selected CN node.

Preferably, the NAS node selection function in the RAN node balances the load between the available CN nodes. This is performed by an appropriate selection of the CN node for an MS which was not yet assigned to a CN node, i.e. when there is no CN node configured for the NRI indicated by the MS, when no NRI can be derived or in exceptional cases, e.g. when the CN node corresponding to an NRI cannot be reached.

In case of handover/relocation into a pool-area a load balancing between all the target CN nodes serving this pool-area is gained by configuration. Source CN nodes which support Intra Domain Connection of RAN Nodes to Multiple CN Nodes may be configured with all possible target CN nodes for each handover/relocation target. Source CN nodes which do not support the Intra Domain Connection of RAN Nodes to Multiple CN Nodes can configure only one target CN node per handover/relocation target. In this case each of source CN nodes which handover/relocate to the same pool-area may be configured with another target CN node out of all target CN nodes serving the same handover/relocation target. The mechanism for distribution of the traffic between the handover/relocation target CN nodes is implementation specific. This load balancing is complemented by the NAS Node selection Function in the RAN, which distributes MSs between the CN nodes when these MSs enter the pool-area in idle mode.

The benefits of the Internet Protocol (IP), and IP enabled Radio Access Network (IP-RAN), can be seen clearly and they can be summarized as follows. The primary driver for the increased usage of IP is derived from operators' abilities to create new and easily customizable services over the de-facto service creation environment, the Internet. Secondly, as the content is expressed in the Internet Protocol, native support for IP makes networks more optimal for this form of traffic and operational, and capital expenditure savings over the whole network are significant. Thirdly, IP integrates various access and transport technologies and standards, including fixed, wireless and mobile, into common service creation and delivery networks.

In order to obtain the most efficient RAN architecture, which is based on using the good characteristics of IP, some functionality has to be relocated between network elements. In the most revolutionary architecture we no longer have a network element commonly known as a BSC (Base Station Controller) or RNC (Radio Network Controller), although this functionality must remain in the RAN. In one embodiment of the IP RAN, there has been chosen to locate some RNC functionality in the BTSs to enable e.g. soft handover and associated signaling to happen along the shortest path, producing minimum delay and signaling load to those parts of networks where this is not necessary. Referring to the above state of art description it can be said that IP RAN is realized by implementing most of the RNC (or BSC) functionality in the BTS (IP BTS). Only Paging, basic O&M (Operation and Maintenance) and configurations, Location Calculation functions and Common Radio Resource Management may be implemented in separate servers outside the BTS site.

In the distributed architecture of IP RAN, the distributed functionalities of RNC/BSC from the CN's or neighbouring radio network's point of view are hidden. In an IP RAN architecture, the introduction of the Radio Network Access Server (RNAS, a signaling GW) and Radio Access Network Gateway (RNGW)/Circuit Switched Gateway (CSGW) (user plane GWs) creates two instances of the Iu interface from the core network towards the IP BTS. The same happens with the Iur interface from a conventional RNC to a IP BTS. The presence of two instances of the Iu and Iur interfaces is the main characteristic of the IP RAN Distributed architecture.

The prior art solutions do not provide a solution for the pooling of RNAS servers in the IP RAN. Without the solution described in the present invention it is not possible to have RNAS pooling, and therefore, no resilience or load balancing.

### SUMMARY OF THE INVENTION

The present invention describes a method for identifying and selecting network nodes in a telecommunication system comprising a core network comprising a plurality of core network nodes, a plurality of radio network access servers belonging to one or more pool-areas, the radio network access servers being connected to one or more core network nodes, one or more IP base stations each of which being connected to one or more radio network access servers and a plurality of mobile terminals connected to one or more IP base stations. An RNAS pool-area is a set of radio network access servers that can be used to connect to a core network node or core network node pool-area.

In the present invention, a radio network access server and a core network node to be used are selected at the time of setting up a signaling connection to the core network. For RNAS pooling, Network Resource Identifier (NRI) is used by an IP BTS to identify the core network node. Address information about the selected core network node to be used in the signaling connection set-up is sent to the selected radio network access server and the signaling connection is set-up to the selected core network node. If the NRI is not available, the default core network node will be used.

In one embodiment, the selection of the core network node and radio network access server is made in an IP base station. In another embodiment, the selection of the radio network access server is made in a node external to the IP base station by sending the core network node identifier to the external node, and selecting the radio network access server in a node external to the IP base station and relaying the selected radio network server information back to the IP base station.

In one embodiment, the node external to the IP base station is informed out of which pool-area(s) the radio network access server should be chosen.

The present invention does not require any changes to the 3^{rd} Generation Partnership Project (3GPP) specifications. Only the Radio Access Network Application Part (RANAP) used inside the IP radio access network need to include an identifier for the core network node. The identifier is in the preferred embodiment incorporated in the RANAP′ Initial UE message (RANAP′ refers to RANAP used inside the IP radio access network) . The identifier can be e.g. a global core network node identifier, an IP address of the core network node or some other proprietary identifier.

The present invention describes a novel method, system, IP base station and radio network access server for the pooling of radio network access servers in the IP radio access network. Further, the present invention enables the selection of a core network node within the Iu′ interface between an IP base station and radio network access server.

The present invention also enables load balancing and fault resilience.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating a prior art telecommunication network,

FIG. 2 is a block diagram illustrating an example of the overall system architecture of a distributed radio access network in which the present invention can be applied,

FIG. 3 is a block diagram illustrating an example of an IP base station and a radio network access server in accordance with the present invention, and

FIG. 4 is a block diagram illustrating an example of an IP base station and a radio network access server in accordance with the present invention.

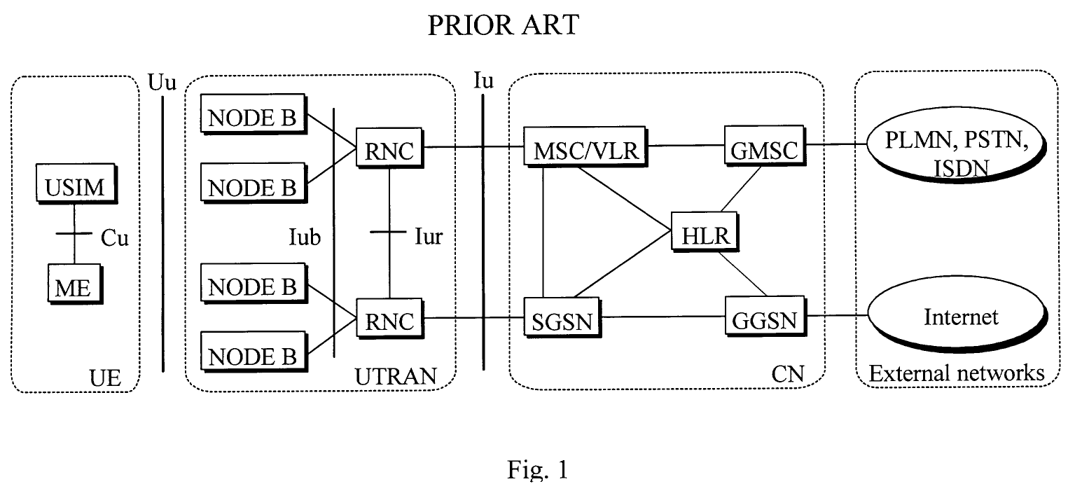

### DETAILED DESCRIPTION OF THE INVENTION

Reference will now be made in detail to the embodiments of the present invention, examples of which are illustrated in the accompanying drawings.

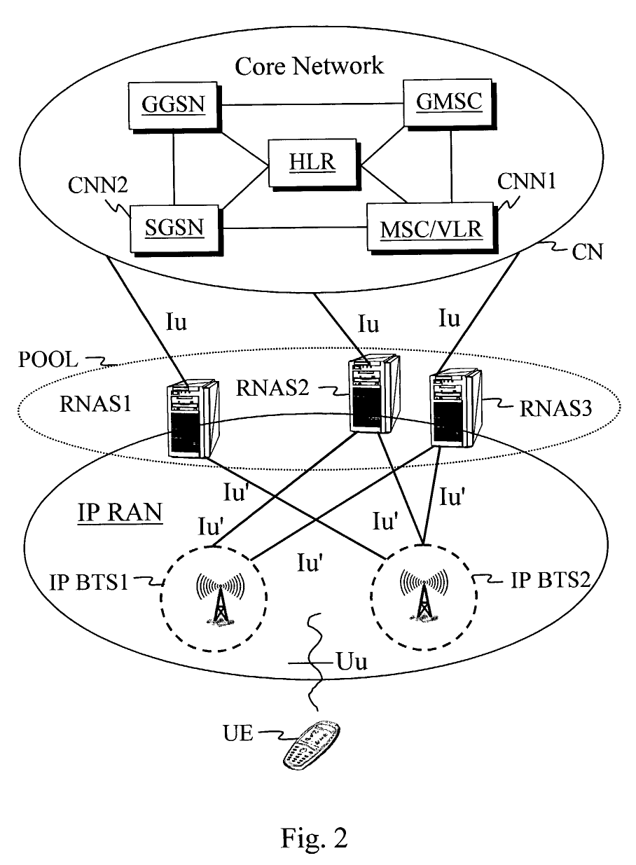

FIG. 2 illustrates an embodiment of a system in which the present invention can be used. The system comprises a core network CN connected to the IP radio access network IP RAN via the Iu interface. The Iu interface is described in more detail e.g. in the 3GPP specifications TS 25.410-25.415.

In FIG. 2, the core network CN comprises a Mobile Switching Center/Visitor Location Register MSC/VLR, Home Location Register HLR, Serving GPRS Support Node (SGSN) and Gateway GPRS Support Node (GGSN). It must be noted that both the core network and the IP radio access network IP RAN may also comprise other network nodes or components not described here.

The IP radio access network IP RAN comprises radio network access servers RNAS1, RNAS2, RNAS3 and IP base stations IP BTS1, IB BTS2. The radio network access servers are connected to the IP base stations via the Iu′ interface. User equipment UE is connected to the IP base stations via the Uu interface. The radio network access server acts as a signaling gateway between the RAN and CN. It e.g. discriminates the control plane messages of the Iu and A interfaces and relays them further. It also can have paging server functions, i.e. the RNAS keeps track of the UE RRC (Radio Resource Control) status and location, processes the idle mode paging messages and other connectionless messages from the core network CN, and forwards them to the IP BTS controlling the cell the message is targeted to. In more detail, the RNAS has, for example, the following functions: RANAP connection termination, setup and release of the signaling connections, discrimination of connectionless messages processing of RANAP connectionless protocol messages; storing of information of the existing radio resource control (RRC) connection, relaying of idle mode paging message to the relevant entities, Reset and overload control, management of reset and overload messages to/from the CN etc.

It must be noted that FIG. 2 in only a simplified figure of a real telecommunication network, and thus, it may comprise additional components and parts not depicted therein.

The present invention discloses the possibility to select a radio network access server among multiple RNASs and also a core network node when setting up a new signaling connection in the IP RAN. Requirements for the RNAS pooling are e.g. the following:

1. RANAP Initial UE Message needs to be sent to the serving or default core network node or, in case of response to Gs paging to the MSC/VLR which originated the paging.

the IP BTS needs to know the RNAS which can reach serving core network node

the RNAS needs to know the serving core network node and have connection to it

the RNAS needs to know the core network node which originated the paging. In case of paging via Gs, the MSC/VLR is different from the serving core network node.

2. For paging co-ordination, paging message should be sent to the same RNAS to which the mobile has a signaling connection.

3. RNAS relocation can happen to multiple RNASs.

In the present invention, the IP base station IP BTS, IP BTS2 selects a core network node CNN1, CNN2 and a radio network access server RNAS1, RNAS2, RNAS3 in the pool-area POOL in connection with the core network node CNN1, CNN2 at the time of setting up a signaling connection to the core network CN. An RNAS pool-area is the set of radio network access servers that can be used to connect to a core network node or core network node pool. The core network node CNN1, CNN2 can be selected based either on the default core network node or the IDNSS IE present in the RRC Initial Direct Transfer message. With user equipment not implementing the IDNSS IE in RRC Initial Direct Transfer message, the predefined default core network node in each IP BTS will be used. The IP base station IP BTS1, IP BTS2 sends the identifier of the selected core network node CNN1, CNN2 to a radio network access server RNAS1, RNAS2, RNAS3 so that the RNAS can setup the signaling connection to the selected core network node CNN1, CNN2.

NAS Node Selection Function (NNSF) is used to select among available core network nodes. NNSF and RNAS selection function are located in the IP base station.

In some systems, as illustrated in FIG. 2, there can be multiple core network nodes CNN1, CNN2 serving one area, so an identifier for a CN node is needed. The Network Resource Identifier (NRI) identifies uniquely an individual core network node out of all core network nodes, which serve in parallel a pool-area. In areas where different pool-areas overlap, the NRI identifies uniquely a core network node out of all core network nodes which serve all these overlapping pool-areas, i.e. an NRI identifies uniquely a core network node within a RAN node.

In one embodiment of FIG. 2, the IP base station may store the MSC/VLR id when paging with IMSI. The core network node identifier that the IP BTS should send to RNAS in that case is the one contained in the paging message.

The present invention requires some changes in the Iu′ interface between a radio network access server and an IP base station. The RANAP′ Initial UE Message has to include an identifier for the core network node. The core network node identifier can e.g. be a Network Resource Identifier, a global core network identifier, an IP address of the core network node or some other proprietary identifier for instance.

In one embodiment of the system of FIG. 2, the IP base station IP BTS1, IP BTS2 keeps a Location Area/Routing Area (LA/RA)-RNAS mapping table. When a new RNAS is selected by the IP BTS, which is different from the RNAS controlling the LA/RA on which the mobile is currently registered, the IP BTS forces the mobile to perform LA/RA update by means of RRC UTRAN mobility information message. In order to avoid ping-pong effect in LA/RA updates when mobile is establishing and releasing Iu signaling connections, which will increase the signaling load, the following rule for selection of RNAS should preferably be used:

The IP BTS's first radio network access node choice should be the RNAS controlling the Location Area (LA) or Routing Area (RA) on which the mobile is currently registered. If this is not possible, then the RRC UTRAN Mobility message should not be used in the case of short-duration Iu signaling connections, since the probability of receiving a paging from the other core network domain in a short connection can be considered negligible. Short-duration Iu signaling connections refers e.g. to the Iu connections not associated with the transfer of user data, but only control information, like LA/RA updates.

The description above assumes that the IP base station makes itself the decision to which radio network access server the signaling connection is set-up. In another embodiment, the decision is made elsewhere. The selection can also be made by an external node and the selection information relayed back to the IP base station. In more detail, the IP base station may send a core network node identifier to the node external to the IP base station. The external node selects one radio network access server that has a connection to the core network node. The IP base station may also indicate to the node external to the IP base station out of which pool-area(s) the radio network access server should be chosen. The selection of a radio network access server can be made based on various reasons, e.g. load balancing, resilience etc.

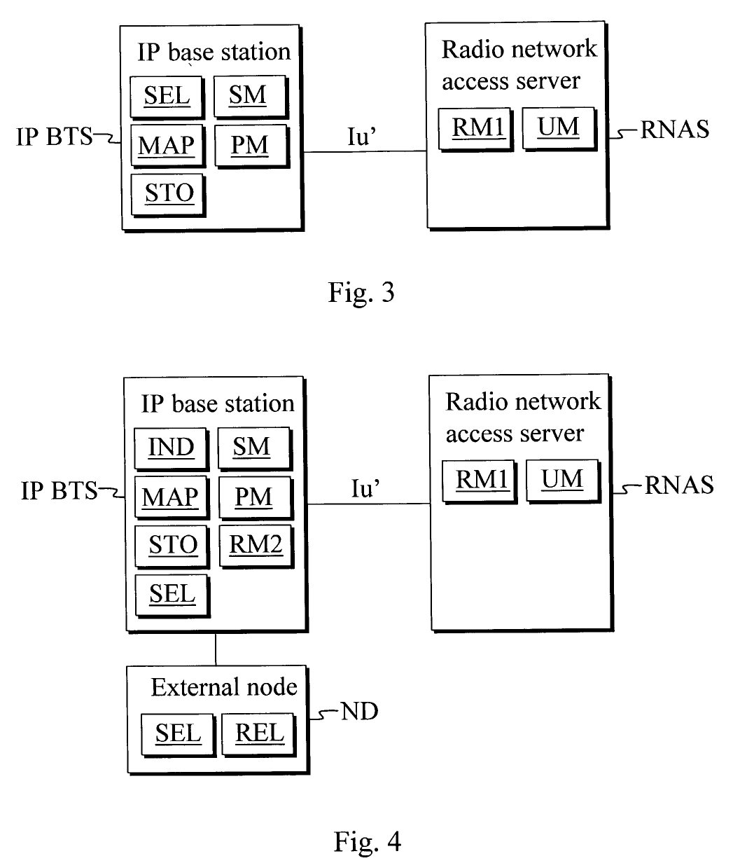

FIG. 3 describes an embodiment of an IP base station and a radio network access server in accordance with the present invention. The IP base station IP BTS comprises selecting means SEL for selecting a core network node and a radio network access server in a pool-area in connection with the core network node at the time of setting up a signaling connection to the core network. The IP base station identifies the core network node preferably by a Network Resource Identifier (NRI). If the Network Resource Identifier is unavailable for the core network node or if a mobile terminal does not implement the IDNSS information element present in the RRC initial direct transfer message, selecting means SELare arranged to use the default core network node.

The IP base station comprises also sending means SM for sending address information of the selected core network node to the radio network access server. The core network node identifier is incorporated preferably in the RANAP′ Initial UE Message. The core network node identifier is a Network Resource Identifier, a global core network identifier or an IP address of the core network node. The IP base station further comprises a mapping table MAP for keeping Location Area/Routing Area-RNAS associations, performing means PM for performing a Location Area/Routing Area update by means of the RRC UTRAN mobility information message when the selected new radio network access server is different from the radio network access server controlling the Location Area/Routing Area and storing means STO for storing the MSC/VLR identity-IMSI association when the IP base station receives a paging request with IMSI.

In one embodiment of FIG. 3, means for selecting SEL are arranged to select the core network node based on the IDNSS information element present in the RRC initial direct transfer message.

In one embodiment of FIG. 3, means for selecting SEL are arranged to select the radio network access server controlling the Location Area or Routing Area on which the mobile terminal is currently registered.

The radio network access server RNAS comprises first receiving means RM1 for receiving address information about the selected core network node to be used in the signaling connection set-up. The information is provided by the IP base station IP BTS. The radio network access server RNAS further comprises using means UM for using the received core network node address information as a destination address for the core network node when setting up a signaling connection. With using means UM the radio network access server is able to extract the core network node identifier from the RANAP′ Initial UE Message. The core network node identifier is preferably a Network Resource Identifier (NRI), a global core network identifier or an IP address of the core network node.

The aforementioned means are preferably implemented by means of software and/or hardware, and therefore, they are not described in more detail.

FIG. 4 describes another embodiment of an IP base station, a node external to the IP base station and a radio network access server in accordance with the present invention.

In the architecture described in FIG. 4, the selection of a core network node and a radio network access server in a pool-area in connection with the core network node at the time of setting up a signaling connection to the core network are arranged partly in the IP base station IP BTS and partly in the external node ND. The selection of the core network node may be made in the IP base station IP BTS and the selection of the radio network access server in the external node ND by the selecting means SEL.

The selection of the radio network access server to be used is made in the external node ND. In one embodiment of FIG. 4, the IP base station sends a core network node identifier to the external node ND. The radio network access server to be used is selected in the external node ND and the selection information is relayed back to the IP base station IP BTS. In one embodiment of FIG. 4, the external node ND is informed by the IP base station IP BTS out of which pool-area(s) the radio network access server should be chosen. In another embodiment of FIG. 4, selecting means SEL are arranged to select the radio network access server controlling the Location Area or Routing Area on which the mobile terminal is currently registered.

The IP base station IP BTS comprises selecting means SEL for selecting a core network node and sending means SM for sending address information of the selected core network node to the radio network access server and for sending the core network node identifier to the external node ND. In one embodiment of FIG. 4, selecting means SEL are arranged to select the core network node based on the IDNSS information element present in the RRC initial direct transfer message. If the Network Resource Identifier is unavailable for the core network node or if a mobile terminal does not implement the IDNSS information element present in the RRC initial direct transfer message, selecting means SEL are arranged to use the default core network node. The core network node identifier is incorporated preferably in the RANAP′ Initial UE Message. The core network node identifier is a Network Resource Identifier, a global core network identifier or an IP address of the core network node.

The IP base station IP BTS further comprises a mapping table MAP for keeping Location Area/Routing Area-RNAS associations, performing means PM for performing a Location Area/Routing Area update by means of the RRC UTRAN mobility information message when the selected new radio network access server is different from the radio network access server controlling the Location Area/Routing Area and storing means STO for storing the MSC/VLR identity-IMSI association when the IP base station receives a paging request with IMSI. Furthermore, the IP base station comprises indicating means IND for indicating to the external node ND out of which pool-area(s) the radio network access server should be chosen and second receiving means RM2 for receiving addressing information about the selected radio network access server from the external node ND.

The external node ND comprises selecting means SEL for selecting the radio network access server and relaying means REL for relaying the selected radio network server information back to the IP base station IP BTS. The selection of the radio network access server can be made based on various reasons, e.g. load balancing, resilience etc. The external node may refer to any appropriate network node or function with which the selection can be made.

The radio network access server RNAS comprises first receiving means RM1 for receiving address information about the selected core network node to be used in the signaling connection set-up. The information is provided by the IP base station IP BTS. The radio network access server RNAS further comprises using means UM for using the received core network node address information as a destination address for the core network node when setting up a signaling connection. With using means UM the radio network access server is able to extract the core network node identifier from the RANAP′ Initial UE Message. The core network node identifier is preferably a Network Resource Identifier (NRI), a global core network identifier or an IP address of the core network node.

The aforementioned means are preferably implemented by means of software and/or hardware, and therefore, they are not described in more detail.

The present invention describes the pooling of radio network access servers in the IP RAN. Furthermore, the present invention enables the selection of core network node in the IP base station. Without the proposed solution it is not possible to have RNAS pooling, and therefore no resilience or load balancing.

It is obvious to a person skilled in the art that with the advancement of technology, the basic idea of the invention may be implemented in various ways. The invention and its embodiments are thus not limited to the examples described above, instead they may vary within the scope of the claims.

1. A method for identifying and selecting network nodes in a telecommunication system comprising a core network comprising at least a plurality of core network nodes, a plurality of radio network access servers belonging to one or more pool-areas, the radio network access servers being connected to one or more core network nodes, one or more IP base stations each of which being connected to one or more radio network access servers and a plurality of mobile terminals connected to one or more IP base stations, wherein the method comprises the step of:
selecting a core network node and a radio network access server in the pool-area in connection with the core network node at the time of setting up a signaling connection to the core network;
sending address information of the selected core network node to be used in the signaling connection set-up to the selected radio network access server; and
setting up the signaling connection to the selected core network.

2. The method according to claim 1, wherein a core network node is identified by a Network Resource Identifier.

3. The method according to claim 1, wherein the method further comprises the step of:
selecting the radio network access server in the IP base station.

4. The method according to claim 1, wherein the method further comprises the steps of:
selecting the radio network access server in a node external to the IP base station; and
relaying the selected radio network server information to the IP base station.

5. The method according to claim 4, wherein the method further comprises the step of:
sending a core network node identifier to the node external to the IP base station.

6. The method according to claim 4, wherein the method further comprises the steps of:
indicating to the node external to the IP base station out of which pool-area(s) the radio network access server should be chosen; and
receiving addressing information about the selected radio network access server from the node external to the IP base station.

7. The method according to claim 1, wherein the method further comprises the step of:
selecting the core network node based on the IDNSS information element present in the RRC initial direct transfer message.

8. The method according to claim 2, wherein if the Network Resource Identifier is unavailable for the core network node or if a mobile terminal does not implement the IDNSS information element present in the RRC initial direct transfer message, the method further comprises the step of:
selecting a default core network node.

9. The method according to claim 1, wherein the method comprises the step of:
adding a core network node identifier to the RANAP′ Iu′ interface between an IP base station and a radio network access server.

10. The method according to claim 9, wherein the core network node identifier is incorporated in the RANAP′ Initial UE Message.

11. The method according to claim 9, wherein the core network node identifier is a global core network node identifier or an IP address of the core network node.

12. The method according to claim 1, wherein the method comprises the steps of:
keeping a Location Area/Routing Area-RNAS mapping table in the IP base station.

13. The method according to claim 12, wherein the method further comprises the steps of:
selecting the radio network access server controlling the Location Area or Routing Area on which the mobile terminal is currently registered.

14. The method according to claim 13, wherein the method further comprises the step of:
performing a Location Area/Routing Area update by means of the RRC UTRAN mobility information message when the selected new radio network access server is different from the radio network access server controlling the Location Area/Routing Area.

15. The method according to claim 1, wherein the method further comprises the step of:
storing in the IP base station the MSC/VLR identity-IMSI association when an IP base station receives a paging request with IMSI.

16. A system for identifying and selecting network nodes in a telecommunication system comprising a core network comprising at least a plurality of core network nodes, a plurality of radio network access servers belonging to one or more RNAS pool-areas, the radio network access servers being connected to one or more core network nodes, one or more IP base stations each of which being connected to one or more radio network access servers and a plurality of mobile terminals connected to one or more IP base stations, wherein the system further comprises:
selecting means for selecting a core network node and a radio network access server in the pool-area in connection with the core network node at the time of setting up a signaling connection to the core network;
sending means for sending address information of the selected core network node to be used in the signaling connection set-up to the selected radio network access server;
first receiving means for receiving address information about the selected core network node to be used in the signaling connection set-up; and
using means for using the received core network node address information as a destination address for the core network node when setting up the signaling connection.

17. The system according to claim 16, wherein a core network node is identified by a Network Resource Identifier.

18. The system according to claim 16, wherein selecting means are arranged in the IP base station.

19. The system according to claim 16, wherein sending means are arranged to send a core network node identifier to a node external to the IP base station.

20. The system according to claim 16, wherein:
selecting means for selecting the radio network access server are arranged in a node external to the IP base station; wherein the system further comprises:
relaying means for relaying the selected radio network access server information to the IP base station.

21. The system according to claim 19, wherein the system further comprises:
indicating means for indicating to the node external to the IP base station out of which pool-area(s) the radio network access server should be chosen; and
second receiving means for receiving addressing information about the selected radio network access server from the node external to the IP base station.

22. The system according to claim 16, wherein selecting means are arranged to select the core network node based on the IDNSS information element present in the RRC initial direct transfer message.

23. The system according to claim 17, wherein if the Network Resource Identifier is unavailable for the core network node or if a mobile terminal does not implement the IDNSS information element present in the RRC initial direct transfer message, selecting means are arranged to use a default core network node.

24. The system according to claim 16, wherein the system further comprises:
a core network node identifier in the RANAP′ Iu′ interface between an IP base station and a radio network access server.

25. The system according to claim 24, wherein the core network identifier is incorporated in the RANAP′ Initial UE Message.

26. The system according to claim 24, wherein the core network node identifier is a global core network identifier or an IP address of the core network node.

27. The system according to claim 16, wherein the system further comprises:
a mapping table for keeping Location Area/Routing Area-RNAS associations in the IP base station.

28. The system according to claim 27, wherein selecting means are arranged to select the radio network access server controlling the Location Area or Routing Area on which the mobile terminal is currently registered.

29. The system according to claim 28, wherein the system further comprises:
performing means for performing a Location Area/Routing Area update by means of the RRC UTRAN mobility information message when the selected new radio network access server is different from the radio network access server controlling the Location Area/Routing Area.

30. The system according to claim 16, wherein the system further comprises:
storing means for storing in the IP base station the MSC/VLR identity-IMSI association when an IP base station receives a paging request with IMSI.

31. An IP base station for identifying and selecting network nodes in a telecommunication system comprising a core network comprising at least a plurality of core network nodes, a plurality of radio network access servers belonging to one or more RNAS pool-areas, the radio network access servers being connected to one or more core network nodes, one or more IP base stations each of which being connected to one or more radio network access servers and a plurality of mobile terminals connected to one or more IP base stations, wherein the IP base station further comprises:
selecting means for selecting a core network node and a radio network access server in the pool-area in connection with the core network node at the time of setting up the signaling connection to the core network; and
sending means for sending address information of the selected core network node to be used in the signaling connection set-up to the selected radio network access server.

32. The IP base station according to claim 31, wherein a core network node network access is identified by a Network Resource Identifier (NRI).

33. The IP base station according to claim 31, wherein sending means are arranged to send a core network node identifier to the node external to the IP base station.

34. The IP base station according to claim 31, wherein:
selecting means for selecting the radio network access server are arranged in a node external to the IP base station; wherein the system further comprises:
relaying means for relaying the selected radio network access server information to the IP base station.

35. The IP base station according to claim 33, wherein the IP base station further comprises:
indicating means for indicating to the node external to the IP base station out of which pool-area(s) the radio network access server should be chosen; and
second receiving means for receiving addressing information about the selected radio network access server from the node external to the IP base station.

36. The IP base station according to claim 31, wherein selecting means are arranged to select the core network node based on the IDNSS information element present in the RRC initial direct transfer message.

37. The IP base station according to claim 32, wherein if the Network Resource Identifier is unavailable for the core network node or if a mobile terminal does not implement the IDNSS information element present in the RRC initial direct transfer message, selecting means are arranged to use a default core network node.

38. The IP base station according to claim 31, wherein a core network node identifier is incorporated in the RANAP′ Initial UE Message.

39. The IP base station according to claim 38, wherein the core network node identifier is a global core network identifier or an IP address of the core network node.

40. The IP base station according to claim 31, wherein the IP base station further comprises:
a mapping table for keeping Location Area/Routing Area-RNAS associations in the IP base station.

41. The IP base station according to claim 40, wherein selecting means are arranged to select the radio network access server controlling the Location Area or Routing Area on which the mobile terminal is currently registered.

42. The IP base station according to claim 41, wherein the IP base station further comprises:
performing means for performing a Location Area/Routing Area update by means of the RRC UTRAN mobility information message when the selected new radio network access server is different from the radio network access server controlling the Location Area/Routing Area.

43. The IP base station according to claim 31, wherein the IP base station further comprises:
storing means for storing the MSC/VLR identity-IMSI association when the IP base station receives a paging request with IMSI.

44. A radio network access server for identifying network nodes in a telecommunication system comprising a core network comprising at least a plurality of core network nodes, a plurality of radio network access servers belonging to one or more RNAS pool-areas, the radio network access servers being connected to one or more core network nodes, one or more IP base stations each of which being connected to one or more radio network access servers and a plurality of mobile terminals connected to one or more IP base stations, wherein the radio network access server further comprises:
first receiving means for receiving address information about a selected core network node to be used in a signaling connection set-up; and
using means for using the received core network node address information as a destination address for the core network node when setting up the signaling connection.

45. The radio network access server station according to claim 44, wherein a core network node network access is identified by a Network Resource Identifier (NRI).

46. The radio network access server according to claim 44, wherein a core network node identifier is incorporated in the RANAP′ Initial UE Message.

47. The radio network access server according to claim 46, wherein the core network node identifier is a global core network identifier or an IP address of the core network node.
